(19) United States
(12) Patent Application Publication
(10) Pub. No.: US 2020/0186862 A1
(43) Pub. Date: Jun. 11, 2020

(54) DOWNLOADABLE AVOD CONTENT

(71) Applicant: Roku, Inc., Los Gatos, CA (US)

(72) Inventors: Gregory Mack Garner, Springdale, AR (US); David Sharp, San Jose, CA (US)

(73) Assignee: Roku, Inc., Los Gatos, CA (US)

(21) Appl. No.: 16/430,990

(22) Filed: Jun. 4, 2019

Related U.S. Application Data
(60) Provisional application No. 62/775,452, filed on Dec. 5, 2018.

(51) Int. Cl. H04N 21/437; H04N 21/81; H04N 21/472; H04N 21/234; H04N 21/442; H04N 21/25; H04N 21/258

(52) U.S. Cl. CPC H04N 21/437; H04N 21/812; H04N 21/47202; H04N 21/25891; H04N 21/44222; H04N 21/44218; H04N 21/252; H04N 21/23424

(57) ABSTRACT

Disclosed herein are system, apparatus, article of manufacture, method and/or computer program product embodiments, and/or combinations and sub-combinations thereof, for providing advertising-based video on demand (AVOD) content to electronic devices. Some embodiments operate by receiving non-AVOD content requested by a user; selecting advertisement types and categories based on at least the user and a type of the non-AVOD content; receiving advertisements corresponding to the selected advertisement types and categories; generating AVOD content comprising the non-AVOD content and the advertisements; and transmitting the AVOD content to the electronic device, wherein the electronic device monitors the user as the advertisements are played to generate monitoring information. The monitoring information indicates whether the user watched the advertisements.

### CROSS-REFERENCE TO RELATED APPLICATIONS

This application claims priority to U.S. Provisional Appl. No. 62/775,452 titled “Downloadable AVOD Content,” filed Dec. 5, 2018, 2018 (Attorney Docket No. 3634.1560000), which is herein incorporated by reference in its entirety.

### BACKGROUND

### Field

This disclosure is generally directed to processing advertising-based video on demand (AVOD) content.

### Background

On demand access to content (such as movies, TV programs, news, music, games, books, etc.) has become ubiquitous. There are a number of on demand models.

For example, SVOD (subscription video on demand) allows users to consume as much content as they would like for a monthly subscription price.

TVOD (transactional video on demand) allows users to purchase content. Users may rent the content for some period of time, or may buy the content.

AVOD (advertising-based video on demand) is free to users. But, much like traditional television, advertisements are inserted into the content.

(The above are general descriptions of SVOD, TVOD and AVOD, and they may vary according to the service or channel.)

Each of these models suffer from disadvantages. For example, with AVOD, the advertisements are often of no interest to users, so they do not pay attention to them. Also, the entity providing a given advertisement is often not provided with any feedback about whether users watched the ad.

### SUMMARY

Provided herein are system, apparatus, article of manufacture, method and/or computer program product embodiments, and/or combinations and sub-combinations thereof, for providing advertising-based video on demand (AVOD) content to electronic devices.

Some embodiments operate by receiving non-AVOD content requested by a user; selecting advertisement types and categories based on at least the user and a type of the non-AVOD content; receiving advertisements corresponding to the selected advertisement types and categories; generating AVOD content comprising the non-AVOD content and the advertisements; and transmitting the AVOD content to the electronic device, wherein the electronic device monitors the user as the advertisements are played to generate monitoring information. The monitoring information indicates whether the user watched the advertisements.

In some embodiments, the advertisement types and categories are selected based on content and advertisement associations generated in a crowdsourced manner, and/or on products the user has purchased using the media device.

In some embodiments, the AVOD content is generated by inserting advertisements in the non-AVOD content in a manner customized to the user and/or the type of the non-AVOD content.

In some embodiments, the electronic device stores the AVOD content for later on-demand playback. Also, the electronic device stores the monitoring information until network connectivity is available to transmit the monitoring information to the media device and/or an ad supporting server.

Some embodiments are directed to an electronic device that includes a display screen; user controls; storage; and at least one processing module. The processing module may be configured to: receive AVOD content comprising non-AVOD content and advertisements, wherein the advertisements were selected based on at least a user of the electronic device and a type of the non-AVOD content; store the AVOD content in the storage; at the command of the user, play the AVOD content on the display screen; and monitor the user as the advertisements are played on the display screen to generate monitoring information, wherein the monitoring information indicates whether the user watched the advertisements.

### BRIEF DESCRIPTION OF THE FIGURES

The accompanying drawings are incorporated herein and form a part of the specification.

FIG. 1 illustrates a block diagram of a multimedia environment where AVOD (advertising-based video on demand) content is streamed and/or downloaded to electronic devices, according to some embodiments.

FIG. 2A illustrates a block diagram of a media device of FIG. 1, according to some embodiments.

FIG. 2B illustrates a block diagram of an electronic device of FIG. 1, according to some embodiments.

FIG. 3 illustrates an example stream or download of AVOD content, according to some embodiments.

FIG. 4 illustrates a flowchart for streaming and/or downloading AVOD content to electronic devices, according to some embodiments.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for streaming and/or downloading AVOD (advertising-based video on demand) content to electronic devices, as well as other devices. According to some embodiments, the advertisements (ads) inserted into the AVOD content may be of greater interest to users, so users are more likely to watch the ads. Also, users may be monitored as they watch AVOD content, and feedback may be shared with the providers of ads (ad providers) regarding whether users watched their respective ads. In some embodiments, AVOD content may be downloaded to electronic devices (such as a user's smart phone or tablet) for later viewing, and the above described feedback may be collected and shared with ad providers even when the AVOD content is watched during times when the user does not have Internet connectivity.

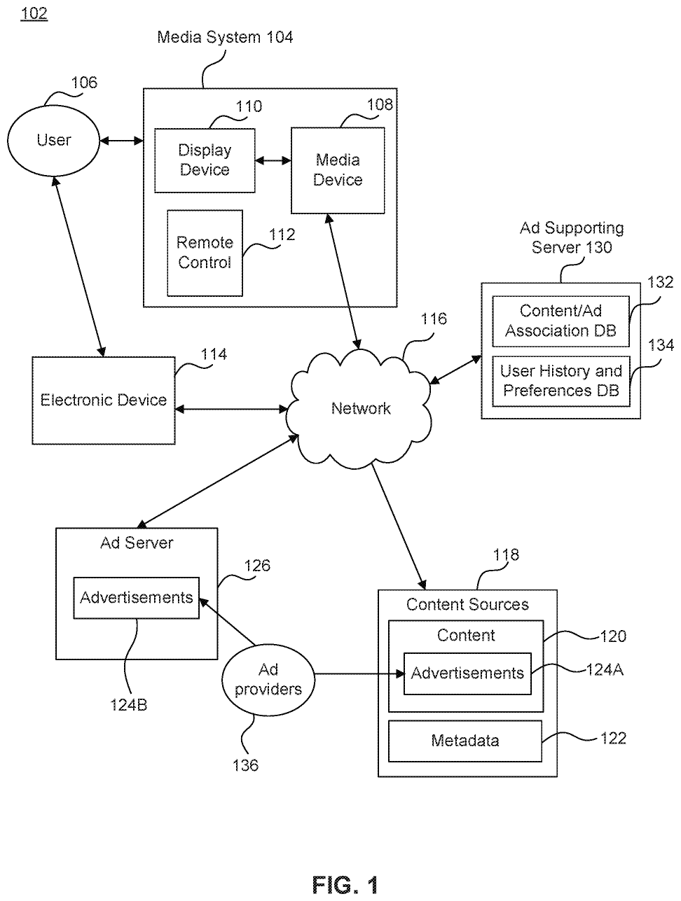

FIG. 1 illustrates a block diagram of a multimedia environment 102, according to some embodiments. In a non-limiting example, multimedia environment 102 is directed to playing content such as movies, TV shows, news, games, audio books, and music, to name just some examples.

The multimedia environment 102 may include a plurality of media systems 104. Each media system 104 may be used by one or more users 106. The media system 104 could be user 106's entertainment system, for example, and could be located in the user 106's home, workplace, vehicle, camp site, or any other location.

Each media system 104 may include one or more media devices 108 each coupled to one or more display devices 110. Media device 108 may be any combination of a streaming media device, over-the-air (OTA) content tuner, DVD/Blu-Ray device, audio/video playback device, cable box, satellite box, and/or digital video recording (DVR) device, to name just a few examples. Display device 110 may be a monitor, television, computer, smart phone, tablet, wearable (such as a watch), appliance, internet-of-things (IoT) device, and/or projector, to name just a few examples. In some embodiments, media device 108 can be a part of, integrated with, operatively coupled to, and/or connected to its respective display device 110.

Each media system 104 may include one or more remote controls 112. The user 106 can use the remote control 112 to control the media device 108 and/or display device 110. The remote control 112 can be a smart phone, tablet, wearable, digital assistant, or any other remote control, and can include voice responsive devices.

The user 106 may also interact with one or more electronic devices 114. The electronic devices 114 may be mobile or non-mobile, and may include smart phones, tablets, wearables (such as smart watches), notebook computers, appliances, vehicles, Internet of Things (IoT) devices, etc., to name just some examples. At any given time, a given electronic device 114 may be proximate to or distant from the media system 104. That is, a given mobile electronic device 114 (such as a smart phone, tablet, wearable, notebook computer, etc.) may travel with the user 106.

The media device 108 may be configured to communicate with network 116. In various embodiments, the network 116 can include, without limitation, wired and/or wireless intranet, extranet, Internet, cellular, Bluetooth and/or any other short range, long range, local, regional, global communications network, as well as any combination thereof.

The multimedia environment 102 may include one or more content servers 118 (also called streaming content providers or sources 118). Each content server 118 may be configured to communicate with network 116.

Each content server 118 may store content 120 and metadata 122. Content 120 may include any combination of music, videos, movies, TV programs, multimedia, images, still pictures, text, graphics, gaming applications, advertisements 124A, programming content, public service content, government content, local community content, software, and/or any other content or data objects in electronic form. Advertisements 124A may be provided by ad providers 136, who may be product manufacturers, service providers, marketing firms, advertising firms, or any other person or entity who wishes to market or advertise a product or service.

In some embodiments, metadata 122 comprises data about content 120. For example, metadata 122 may include a programming schedule of the content 120, that lists content 120 that is available to be streamed to users 106. The metadata 122 may also include associated or ancillary information indicating or related to writer, director, producer, composer, artist, actor, summary, chapters, production, history, year, trailers, alternate versions, related content, applications, and/or any other information pertaining or relating to the content 120. Metadata 122 may also or alternatively include links to any such information pertaining or relating to the content 120. Metadata 122 may also or alternatively include one or more indexes of content 122, such as but not limited to a trick mode index.

The multimedia environment 102 may include one or more ad servers 126. Ad servers 126 operate to serve (that is, provide) advertisements 124B to entities who request ads. As discussed above, advertisements 124B may be provided by ad providers 136, who may be the same or different from the ad providers 136 who provide the advertisements 124A stored in content sources 118. In some embodiments, content sources 118 may operate as ad servers.

The multimedia environment 102 may include one or more ad supporting servers 130 that include content/ad association database 132 and user history and preferences database 134. It is noted that a given ad supporting server 130 may be a dedicated server, or may be part of another server that performs functions that are beyond the scope of this disclosure.

The content/ad association database 132 may include information that associates content type with ad type, to thereby identify the type of ads that may be of interest to people who are watching content of a particular content type. For example, people watching animal documentaries may be interested in ads from non-profit organizations that support animals. People watching action movies may be interested in ads for certain video games. People watching football games may be interested in ads for beer or trucks, or in ads where football players appear. Other associations between content type and ad type will be apparent to persons skilled in the relevant art(s). The content/ad association database 132 may be populated by ad providers 136, or people/companies/organizations who support or are otherwise in the same business as ad providers 136, and/or may be populated or augmented in a crowd sourced manner, as described below.

The user history and preferences database 134 may include information regarding a given user 106's content viewing history and preferences, such as movies and TV programs the user 106 has watched, whether the user 106 watches news or sports, whether the user 106 watches action, drama or comedies, the actors the user watches the most, charities the user has donated to using the media device 108, the user's political affiliation (based on whether the user 106 watches MSNBC or FOX, for example), the products the user has purchased (using the media device 108), etc. The user history and preferences database 134 may also include information indicating the type of ads the user 106 appears to have watched and paid attention to in the past.

The user history and preferences database 134 may be populated by media devices 108 located throughout the world, as these media devices 108 monitor the actions of their respective users 106 while using the media device 108 and/or electronic devices 114. This is further described below.

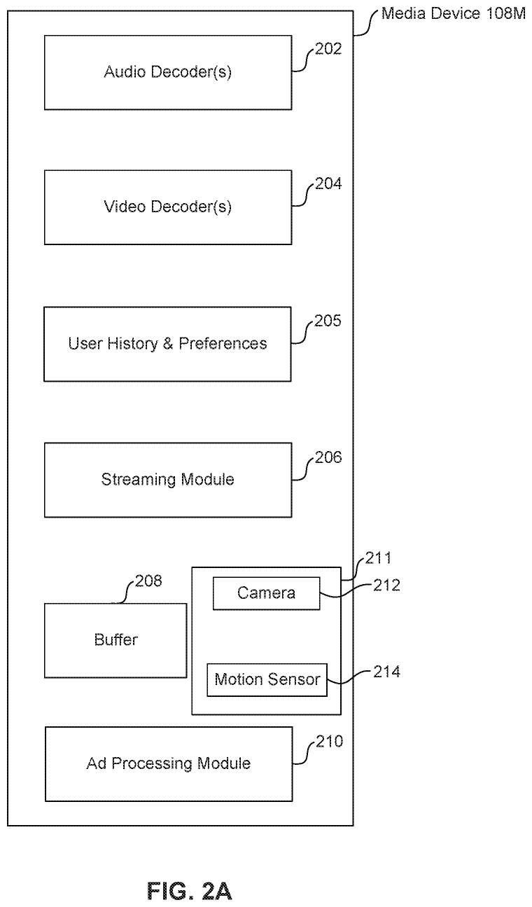

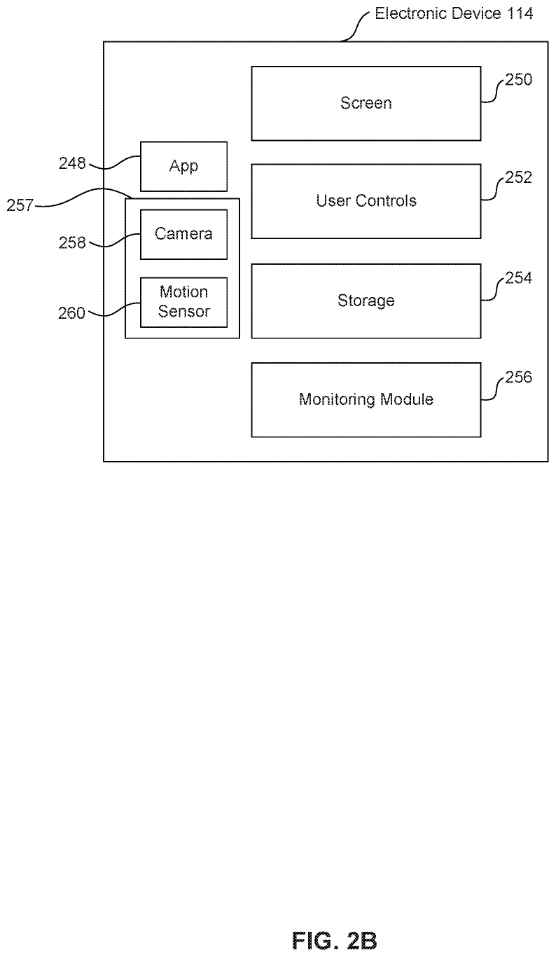

FIG. 2A illustrates a block diagram of an example media device 108, according to some embodiments. Media device 108 may include one or more audio decoders 202 and one or more video decoders 204.

Each audio decoder 202 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 204 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

The media device 108 may also include a buffer 208 and streaming module 206. The streaming module 206 may operate to obtain content 120 (that was requested by user 106) from a content source 118 via the network 116. The media device 108 may transmit the received content 120 to its associated display device 110 and/or to an electronic device 114 for presentation to the user 106 who requested the content.

In some embodiments, the received content 120 may be temporarily buffered in the buffer 208 for some time period before being provided to the display device 110/electronic device 114 for playback. Such buffering may be performed, for example, to synchronize audio and video playback, or to support processing by the audio decoders 202 and/or video decoders 204.

In some embodiments, the media device 108 may include sensors 211 for monitoring the actions of users 106 who are using the media device 108. Such sensors 211 may include a camera 212 and motion sensor 214, to name just two examples.

The media device 108 may store user history and preferences 205. Such user history and preferences 205 may include information that pertains to users 106 who use the media device 108 and/or electronic device 114, that was downloaded from the ad supporting server 130. User history and preferences 205 may also or alternatively include information that was obtained by the media device 108 and/or electronic device 114 while monitoring the action of users 106; this is further described below.

The media device 108 may also include an ad processing module 210. Ad processing module 120 may operate with the streaming module 206, to embed ads in content 120 while the content 120 is being played on the display device 110 or downloaded to electronic devices 114. The ad processing module 120 may obtain such ads from ad servers 126 and/or content sources 118.

The ad processing module 210 may also monitor the actions of users 106, to determine if users 106 watched and paid attention to ads that were played on the display device 110. For example, the ad processing module 120 may monitor if the user 106 used the remote control 112 to fast forward through an ad; this may indicate that the user 106 was not interested in the ad. The ad processing module 120 may also monitor if the user 106 used the remote control 112 to rewind and play the ad again; this may indicate the user 106 was interested in the ad. The ad processing module 120 may also use sensors 211 to discern whether the user 106 watched a given ad. For example, the ad processing module 120 may use the camera 212 to track the user 106's eye movements, to determine if the user 106 watched the ad or was looking at something else while the ad played. The ad processing module 120 may use the motion sensor 214 to determine if the user 106 left the vicinity of the display device 110 while the ad was playing.

The ad processing module 120 may store this monitoring information as part of the user history and preferences 205. Periodically, the ad processing module 120 may transfer this monitoring information to the ad supporting servers 130. The ad supporting servers 130 may store this monitoring information for that user 106 in the user history and preferences database 134.

The ad supporting servers 130 may also use this monitoring information in a crowd sourced manner to update and improve the content/ad association database 132. For example, suppose the media device 108 provided the following monitoring information about user 106 to the ad supporting server 130: (1) the user 106 was watching a football game while a given ad played; (2) the user 106 is female; (3) the ad was related to furniture polish; and (4) the user 106 appeared to watch and pay attention to the ad. Also suppose that a number of media devices 108 (greater than a defined threshold) in a particular geographical region provided similar information regarding their respective users 106 to the ad supporting server 130. In this example, the ad supporting server 130 may create a new association in the content/ad association database 132. This new association would associate: (1) females; (2) located in the particular geographical region; (3) while watching football, with furniture polish. Thereafter in the future, when there is a need to serve an ad to a female user who lives in the particular geographical region and is watching football, this new association would cause an advertisement for furniture polish to be played for this user.

FIG. 2B illustrates a block diagram of an example electronic device 114, according to some embodiments. As noted above, electronic device 114 may be mobile or non-mobile, and may include smart phones, tablets, wearables (such as smart watches), notebook computers, appliances, vehicles, Internet of Things (IoT) devices, etc., to name just some examples.

The electronic device 114 may include a software application (app) 248, for enabling the electronic device 114 to receive, store and play content 120 as described herein.

The electronic device 114 may include a display screen 250 and user controls 252. The user controls 252 may include a keypad, pointing function, audio responsive control mechanism (such as a microphone and voice recognition), etc., to name just some examples. The user controls 252 may be at least partially integrated with the display screen 250, where the display screen 250 is a touch screen, for example.

The electronic device 114 may include storage 254. Storage 254 may be used to store, for example, downloaded AVOD content as well as other types of content and information.

The electronic device 114 may also include a monitoring module 256. Similar to the ad processing module 210 in the media device 108 described above, the monitoring module 256 may monitor the actions of the user 106 as AVOD content is played on the screen 250, to determine if the user 106 watched and paid attention to ads that are played as part of the AVOD content. For example, the monitoring module 256 may monitor if the user 106 used the user controls 252 to fast forward through an ad; this may indicate that the user 106 was not interested in the ad. The monitoring module 256 may also monitor if the user 106 used the user controls 252 to rewind and play the ad again; this may indicate the user 106 was interested in the ad. The monitoring module 256 may also use sensors 257 to discern whether the user 106 watched a given ad. For example, the monitoring module 256 may use the camera 258 to track the user 106's eye movements, to determine if the user 106 watched the ad or was looking at something else while the ad played. The monitoring module 256 may use the motion sensor 260 to determine if the user 106 left the vicinity of the electronic device 114 while the ad was playing.

The monitoring module 256 may store this monitoring information in storage 254. Periodically, the monitoring module 256 may transfer this monitoring information to the ad supporting servers 130 and/or the media device 108. The media device 108 and ad supporting servers 130 may store and utilize this monitoring information as described herein.

It is noted that the monitoring module 256 may be part of or separate from the app 248 in the electronic device 114.

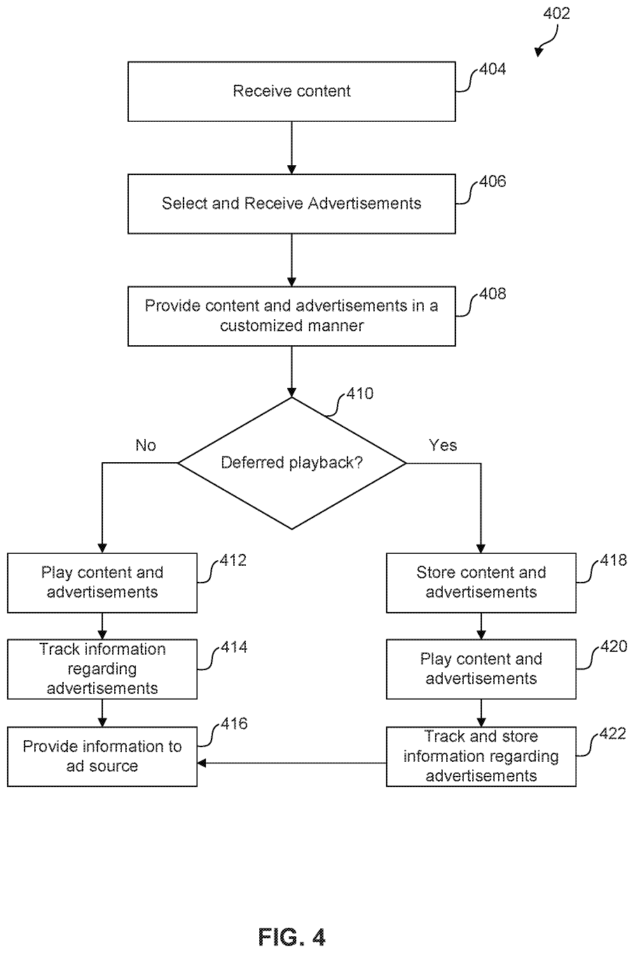

FIG. 4 is a flowchart of a method 402 for providing and processing AVOD content to an electronic device, according to some embodiments. Method 402 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 402 shall be described with reference to FIGS. 1-3. However, method 402 is not limited to those example embodiments.

In 404, the media device 108 receives content 120 from a content source 118 via the network 116, for delivery to and playback on the electronic device 114. The content 120 may have been requested by a user 106 who is using the electronic device 114. In some embodiments, the received content 120 is not AVOD content, and does not contain any advertisements embedded therein. Also in 404, the media device 108 may receive metadata 122 pertaining to the received content 120.

In 406, the ad processing module 210 in the media device 108 analyzes the received metadata 122 and/or history and preferences of the user 106. Such history and preferences may be retrieved from the user history and preferences 205 stored on the media device 108, and/or accessed from the ad supporting server 130. The media device 108 may also access information from the content/ad association database 132 that pertains to the received content 120 (as indicated by the received metadata 122, for example). Based on this analysis, the media device 108 identifies categories or types of ads that are likely to be of interest to the user 106.

For instance, using the above example, if the user 106 is female, lives in the particular geographical region and the content 120 pertains to football, then the ad processing module 210 may identify furniture polish as a type of ad that would be of likely interest to the user 106. If the history and preferences of the user 106 indicate the user 106 has purchased ramen noodles from a local carryout restaurant, then the ad processing module 210 may identify ads for local Asian carryout restaurants to be of likely interest to the user 106. Similar processing of the ad processing module 210 will be apparent to persons skilled in the relevant art(s).

Then in 406, the media device 108 requests ads of these categories/types from ad servers 126 and/or content sources 118. The media device 108 receives these ads 124 via the network 116.

In 408, the media device 108 transmits the non-AVOD content 120 (that was received in 404) and the ads 124 (that were selected and received in 406) to the electronic device 114. In doing so, the media device 108 inserts the ads 124 into the content 120 in a customized manner. For example, based on the user 106's history, the media device 108 may know that the user 106 prefers ads at the beginning of a movie (like trailers), or spaced every 5 minutes, or at scene changes, to name just some examples. As another example, media device 108 may also know (from crowdsourced information provided by the ad supporting service 130) the best times to insert a given ad into a given movie or TV show (or other content) so as to increase the likelihood that the user 106 will watch and pay attention to the ad. Accordingly, based on this information and analysis, in 408, the media device 108 transmits the non-AVOD content 120 and the ads 124 to the electronic device 114 in a manner customized to the user 106 who will be watching the content 120 and ads 124.

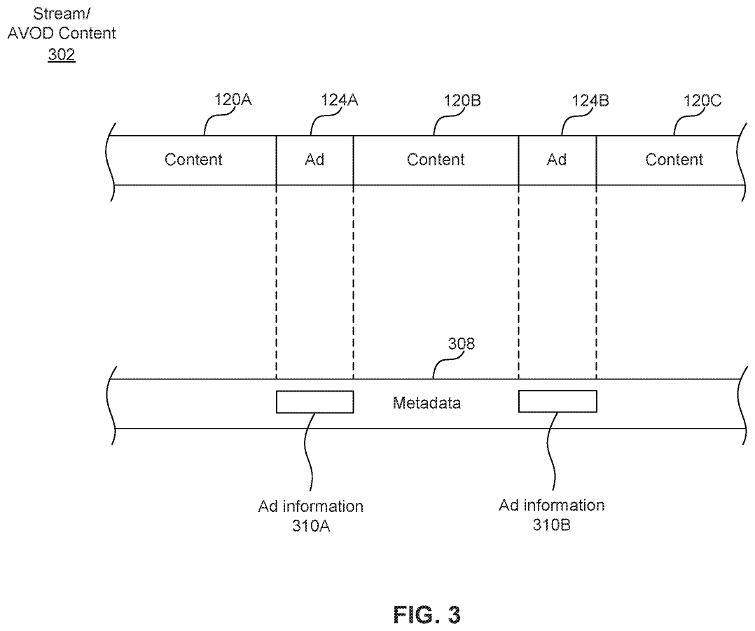

FIG. 3 illustrates an example stream 302 of content 120 and ads 124 transmitted to the electronic device 114 from the media device 104 via the network 116, as a function of 408. In the example of FIG. 3, two ads 124A and 124B have been inserted into content 120. As described above, the ads 124 have been selected and inserted in the content 120 in a manner customized to the user 106. It is noted that the stream 302 as generated by the media device 108 essentially constitutes AVOD content. Accordingly, stream 302 may also be called AVOD content 302 herein.

As part of 408, the media device 108 generates and/or augments metadata 308 (which may also include at least part of the metadata 122 received in 404) with ad information 310 pertaining to the inserted advertisements 124A, 124B. Such ad information 310 may include at least information that specifies the location of the ads 124A, 124B in the stream 302. The media device 108 may also provide the metadata 308 to the electronic device 114 in 408. The metadata 308 may be separate or a part of the AVOD content 302.

In 410, the electronic device 114 determines if the user 106 wishes to consume the content 120 immediately, or if the user 106 wishes to consume the content 120 at a later time (that is, the user 106 wishes deferred playback). If deferred feedback, the user 106 might be downloading the content 120 now because he wishes to watch the content 120 later when he is on a plane or otherwise in a location with limited or not connectivity.

If it is determined that the user 106 desires to consume the content 120 immediately, then 412 is performed. In 412, the app 248 receives the AVOD content 302 containing the content 120 and ads 124, and plays the AVOD content 302 on the screen 250 for consumption by the user 106. The user 106 may control playback using the user controls 252 (rewind, fast forward, pause, etc.), and the AVOD content 302 may be buffered in the storage 254 as necessary.

In 414, the monitoring module 256 in the electronic device 114 may monitor the user 106's actions while the ads 124 are being played on the screen 250. The monitoring module 256 knows when the ads 124 play based on the ad information 310 in the metadata 308, that specifies the location of the ads 124A, 124B in the AVOD content 302. The monitoring module 256 may monitor the user 106's action in 414 as described above.

In 416, the monitoring module 256 may provide the monitoring information (obtained in 414) to the ad supporting server 130, for processing as described above. The monitoring module 256 and/or the ad supporting server 130 may provide at least some of this monitoring information to the ad providers 136 who respectively provided the ads 124A, 124B. In this way, the ad providers 136 obtain feedback about whether users 106 watched and paid attention to their ads 124A, 124B. Using this information, ad providers 136 may be better able to improve and monetize their ads 124.

Referring back to 410, if the user 106 indicated deferred playback, then 418 is performed.

In 418, the app 248 stores the AVOD content 302 as it is received in the storage 254.

In 420, at the command of the user 106, the app 248 causes the AVOD content 302 to be played on the screen 250 from the storage 254. The user 106 may control playback using the user controls 252 (rewind, fast forward, pause, etc.).

In 422, the monitoring module 256 in the electronic device 114 may monitor the user 106's actions while the ads 124 are being played on the screen 250. 422 is similar to 414, but in the case of deferred playback, the electronic device 114 may be in a location with limited or no connectivity to network 116. Accordingly, if the electronic device 114 determines that there is limited or no connectivity, then the app 248 may store this monitoring information in the storage 254.

Then, when connectivity is restored, 416 is performed as described above.

Accordingly, some embodiments of this disclosure enable AVOD content to be generated in a customized manner, and to be downloaded to electronic devices for immediate or deferred playback. Some embodiments also monitor user activity while ads are played, to determine if the user watched and paid attention to the ads. This monitoring feedback may be provided to ad providers.

It is noted that additional embodiments for providing content (particularly over-the-air, OTA, content) to electronic devices are described in U.S. patent application Ser. No. ______, titled “Providing Over-The-Air Content To Any Device,” filed herewith, which is herein incorporated by reference in its entirety, and these OTA embodiments may be combined with any of the AVOD embodiments described herein.

### Example Computer System

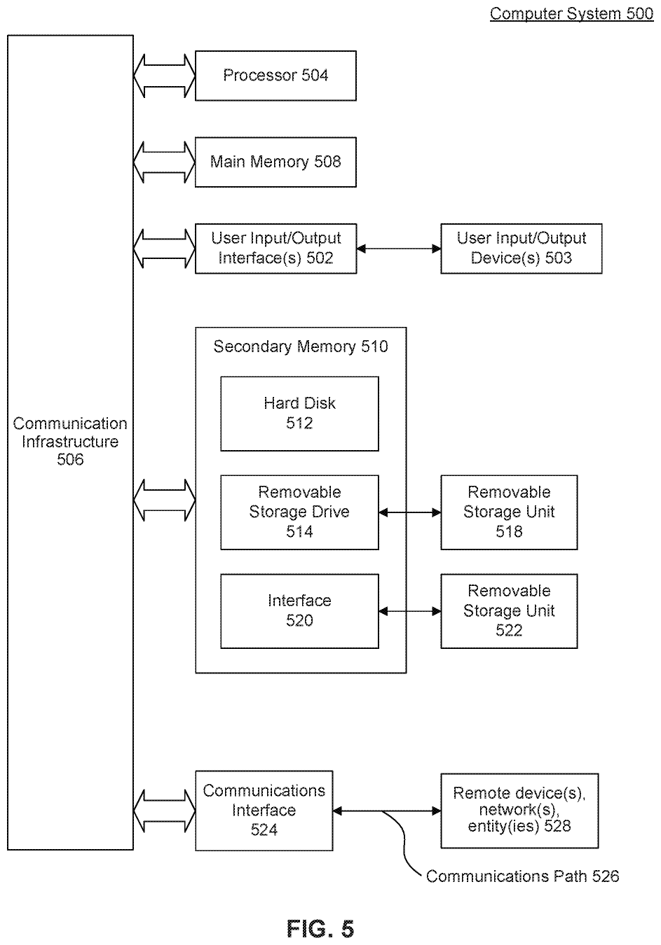

Various embodiments and/or components therein can be implemented, for example, using one or more computer systems, such as computer system 500 shown in FIG. 5. Computer system 500 can be any computer or computing device capable of performing the functions described herein. For example, one or more computer systems 500 or portions thereof can be used to implement any embodiments of FIGS. 1-4, and/or any combination or sub-combination thereof.

Computer system 500 includes one or more processors (also called central processing units, or CPUs), such as a processor 504. Processor 504 is connected to a communication infrastructure or bus 506.

One or more processors 504 can each be a graphics processing unit (GPU). In some embodiments, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 can include one or more levels of cache. Main memory 508 has stored therein control logic (i.e., computer software) and/or data.

Computer system 500 can also include one or more secondary storage devices or memory 510. Secondary memory 510 can include, for example, a hard disk drive 512 and/or a removable storage device or drive 514. Removable storage drive 514 can be a floppy disk drive, a magnetic tape drive, a compact disk drive, an optical storage device, tape backup device, and/or any other storage device/drive.

Removable storage drive 514 can interact with a removable storage unit 518. Removable storage unit 518 includes a computer usable or readable storage device having stored thereon computer software (control logic) and/or data. Removable storage unit 518 can be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 can include other means, instrumentalities or other approaches for allowing computer programs and/or other instructions and/or data to be accessed by computer system 500. Such means, instrumentalities or other approaches can include, for example, a removable storage unit 522 and an interface 520. Examples of the removable storage unit 522 and the interface 520 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 can further include a communication or network interface 524. Communication interface 524 enables computer system 500 to communicate and interact with any combination of remote devices, remote networks, remote entities, etc. (individually and collectively referenced by reference number 528). For example, communication interface 524 can allow computer system 500 to communicate with remote devices 528 over communications path 526, which can be wired and/or wireless, and which can include any combination of LANs, WANs, the Internet, etc. Control logic and/or data can be transmitted to and from computer system 500 via communication path 526.

In some embodiments, a non-transitory, tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

It is to be appreciated that the Detailed Description section, and not the Summary and Abstract sections, is intended to be used to interpret the claims. The Summary and Abstract sections can set forth one or more but not all exemplary embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method in a media device for providing advertising-based video on demand (AVOD) content to an electronic device, comprising:
receiving non-AVOD content requested by a user;
selecting advertisement types and categories based on at least the user and a type of the non-AVOD content;
receiving advertisements corresponding to the selected advertisement types and categories;
generating AVOD content comprising the non-AVOD content and the advertisements; and
transmitting the AVOD content to the electronic device, wherein the electronic device monitors the user as the advertisements are played to generate monitoring information, and wherein the monitoring information indicates whether the user watched the advertisements.

2. The method of claim 1, wherein the selecting advertisement types and categories comprises:
selecting the advertisement types and categories based on content and advertisement associations generated in a crowdsourced manner.

3. The method of claim 1, wherein the selecting advertisement types and categories comprises:
selecting the advertisement types and categories based on products the user has purchased using the media device.

4. The method of claim 1, wherein the generating AVOD content comprises:
inserting the advertisements in the non-AVOD content in a manner customized to the user and/or the type of the non-AVOD content.

5. The method of claim 1, wherein the electronic device stores the AVOD content for later on-demand playback, and wherein the electronic device stores the monitoring information until network connectivity is available to transmit the monitoring information to the media device.

6. The method of claim 1, wherein the electronic device monitors the user as the advertisements are played by using a camera and/or motion sensor in the electronic device.

7. A tangible computer-readable device having instructions stored thereon that, when executed by at least one computing device in a media device, cause the at least one computing device to perform operations for providing advertising-based video on demand (AVOD) content to an electronic device, the operations comprising:
receiving non-AVOD content requested by a user;
selecting advertisement types and categories based on at least the user and a type of the non-AVOD content;
receiving advertisements corresponding to the selected advertisement types and categories;
generating AVOD content comprising the non-AVOD content and the advertisements; and
transmitting the AVOD content to the electronic device, wherein the electronic device monitors the user as the advertisements are played to generate monitoring information, and wherein the monitoring information indicates whether the user watched the advertisements.

8. The tangible computer-readable device of claim 7, wherein the selecting advertisement types and categories comprises:
selecting the advertisement types and categories based on content and advertisement associations generated in a crowdsourced manner.

9. The tangible computer-readable device of claim 7, wherein the selecting advertisement types and categories comprises:
selecting the advertisement types and categories based on products the user has purchased using the media device.

10. The tangible computer-readable device of claim 7, wherein the generating AVOD content comprises:
inserting the advertisements in the non-AVOD content in a manner customized to the user and/or the type of the non-AVOD content.

11. The tangible computer-readable device of claim 7, wherein the electronic device stores the AVOD content for later on-demand playback, and wherein the electronic device stores the monitoring information until network connectivity is available to transmit the monitoring information to the media device.

12. The tangible computer-readable device of claim 7, wherein the electronic device monitors the user as the advertisements are played by using a camera and/or motion sensor in the electronic device.

13. An electronic device, comprising:
a display screen;
user controls;
storage; and
at least one processing module configured to:
receive AVOD content comprising non-AVOD content and advertisements, wherein the advertisements were selected based on at least a user of the electronic device and a type of the non-AVOD content;
store the AVOD content in the storage;
at the command of the user, play the AVOD content on the display screen; and
monitor the user as the advertisements are played on the display screen to generate monitoring information, wherein the monitoring information indicates whether the user watched the advertisements.

14. The electronic device of claim 13, wherein the advertisement were selected based on content and advertisement associations generated in a crowdsourced manner.

15. The electronic device of claim 13, wherein the advertisement were selected based on products the user has purchased using the media device.

16. The electronic device of claim 13, wherein the AVOD content was generated by inserting the advertisements in the non-AVOD content in a manner customized to the user and/or the type of the non-AVOD content.

17. The electronic device of claim 13, the at least one processing module further configured to:
store the monitoring information until network connectivity is available to transmit the monitoring information to a media device and/or an ad supporting server.

18. The electronic device of claim 13, wherein to monitor the user, the at least one processing module is further configured to:
monitor actions of the user with the user controls.

19. The electronic device of claim 13, also comprising sensors, wherein to monitor the user, the at least one processing module is further configured to:
monitor actions of the user using at least some of the sensors.
